(19) United States
(12) Patent Application Publication
(10) Pub. No.: US 2008/0310502 A1
(43) Pub. Date: Dec. 18, 2008

(54) INTER MODE DETERMINATION METHOD FOR VIDEO ENCODER

(75) Inventors: Byung-Gyu KIM, Busan (KR); Debi Prosad Dogra, Daejeon (KR); Chang-Sik Cho, Daejeon (KR)

Correspondence Address: STAAS & HALSEY LLP, SUITE 700, 1201 NEW YORK AVENUE, N.W., WASHINGTON, DC, 20005, US

(73) Assignee: ELECTRONICS AND TELECOMMUNICATIONS RESEARCH INSTITUTE, Daejeon (KR)

(21) Appl. No.: 12/056,922

(22) Filed: Mar. 27, 2008

(30) Foreign Application Priority Data
Jun. 12, 2007 (KR) 10-2007-0057184

(51) Int. Cl. H04N 7/26

(52) U.S. Cl. 375/240.02; 375/E07.127

(57) ABSTRACT

The present invention relates to a method for a video encoder to determine an inter mode. The video encoder selects initial candidate modes by using inter mode information of a previous frame so as to determine the inter mode, estimates a macroblock having the greatest correlation with a current macroblock in the previous frame, compares the rate-distortion cost of the corresponding macroblock and the rate-distortion cost of the selected mode from among the initial candidate modes, and determines whether to terminate the inter mode determination process early. When the early termination condition is satisfied, the video encoder determines the candidate mode having the minimum rate-distortion cost from among the initial candidate modes as the inter mode of the current macroblock, and terminates the inter mode determination process early. When the early termination condition is not satisfied, the video encoder additionally performs an inter prediction process by selecting additional candidate modes, and determines the candidate mode having the determined minimum rate-distortion cost as the inter mode of the current macroblock.

### CROSS-REFERENCE TO RELATED APPLICATION

This application claims priority to and the benefit of Korean Patent Application No. 10-2007-0057184 filed in the Korean Intellectual Property Office on Jun. 12, 2007, the entire contents of which are incorporated herein by reference.

### BACKGROUND OF THE INVENTION

(a) Field of the Invention

The present invention relates to an inter mode determination method for a video encoder.

This work was supported by the IT R&D program of MIC/IITA [2005-S-022-02, Embedded Software-based SmarTown Solotion].

(b) Description of the Related Art

Regarding the process for a video encoder based on the H.264/AVC (advanced video coding) method to compress block-based video data, residual data are reduced by the prediction encoding method, and block discrete cosine transform (DCT), quantization, and entropy coding are performed on the residual image, mode information, and motion vector to thus generate compressed data streams.

In this instance, the prediction encoding method is divided into inter prediction and intra prediction. The inter prediction uses the temporal correlation of the previous image, and the intra prediction uses the spatial correlation thereof. For example, the H.264/AVC based video encoder performs the intra prediction on the I-frame, and performs the inter prediction and intra prediction on the P-frame or B-frame.

Exemplarily, in the inter prediction, the inter mode is divided into SKIP, 16×16, 16×8, 8×16, 8×8, 8×4, 4×8, and 4×4, and the minimum rate-distortion costs for the respective modes are calculated. The minimum rate-distortion costs for the modes are compared, and the inter mode showing the minimum rate-distortion cost is selected as the final mode and is then compressed.

Intra prediction and inter prediction are applied to the P-frame and the B-frame for each macroblock. The mode having the lesser rate-distortion cost from among the inter mode and the intra mode that are selected according to the rate-distortion cost is selected as the final prediction mode of the current macroblock.

The inter/intra prediction allows the video encoder to increase the compression efficiency while minimizing the video data loss. However, realization of the inter/intra prediction generates a large volume of complexity since various types of inter/intra prediction processes must be performed for the respective macroblocks. Further, the huge complexity may restrict the system for processing video data in real-time.

The above information disclosed in this Background section is only for enhancement of understanding of the background of the invention and therefore it may contain information that does not form the prior art that is already known in this country to a person of ordinary skill in the art.

### SUMMARY OF THE INVENTION

The present invention has been made in an effort to reduce the complexity of a video encoder's determination on an inter mode.

In one aspect of the present invention, a method for determining an inter mode in a method for a video encoder to select an inter mode of a current macroblock to be encoded in a current frame includes: selecting a first minimum cost mode by using inter mode information on a macroblock of a previous frame corresponding to the current macroblock; estimating a maximum correlation macroblock having a maximum correlation with the current macroblock in the previous frame; and determining an inter mode of the current macroblock based on a rate-distortion cost of the first minimum cost mode and a rate-distortion cost of the maximum correlation macroblock.

In another aspect of the present invention, a method for determining an inter mode in a method for a video encoder to select an inter mode of a current macroblock to be encoded in a current frame includes: selecting at least one initial candidate mode by using inter mode information on a macroblock of a previous frame corresponding to the current macroblock; selecting a minimum cost mode from among the at least one initial candidate mode; determining whether to terminate the inter mode determination process based on a rate-distortion cost of the minimum cost mode; and determining the inter mode according to the determination result, and the step of determining the inter mode includes determining the minimum cost mode as the inter mode when the inter mode determination process is finished, and selecting at least one additional candidate mode and determining the inter mode from among the minimum cost mode and the at least one additional candidate mode when the inter mode determination process is not finished.

### BRIEF DESCRIPTION OF THE DRAWINGS

FIG. 1 is a schematic diagram of a video encoder according to an exemplary embodiment of the present invention to encode data.

FIG. 2 is a flowchart for a video encoder according to an exemplary embodiment of the present invention to encode data.

FIG. 3 is a flowchart for a video encoder according to an exemplary embodiment of the present invention to select an initial candidate mode so as to select an inter mode.

FIG. 4 shows candidate modes used for general inter prediction.

FIG. 5 is a tree-type candidate mode for general inter prediction.

FIG. 6 show initial candidate modes according to an exemplary embodiment of the present invention.

FIG. 7 is a flowchart for a video encoder according to an exemplary embodiment of the present invention to determine an early termination for an inter mode determination process.

FIG. 8 is a method for tracking the area having the greatest correlation with the current macroblock in the previous frame according to an exemplary embodiment of the present invention.

FIG. 9 is a method for tracking the area having a great correlation with the current macroblock according to an exemplary embodiment of the present invention.

FIG. 10 is a flowchart for a video encoder according to an exemplary embodiment of the present invention to determine the inter mode according to selection of an additional candidate mode.

FIG. 11 is an example of selecting an additional candidate mode according to an exemplary embodiment of the present invention.

FIG. 12 shows brightness averages for the 8×8 block of Case 2 and Case 3 according to an exemplary embodiment of the present invention.

FIG. 13 shows an example in which brightness averages for the 8×8 block of Case 2 and Case 3 according to an exemplary embodiment of the present invention show diagonal binary patterns.

### DETAILED DESCRIPTION OF THE EMBODIMENTS

In the following detailed description, only certain exemplary embodiments of the present invention have been shown and described, simply by way of illustration. As those skilled in the art would realize, the described embodiments may be modified in various different ways, all without departing from the spirit or scope of the present invention. Accordingly, the drawings and description are to be regarded as illustrative in nature and not restrictive. Like reference numerals designate like elements throughout the specification.

Throughout this specification and the claims which follow, unless explicitly described to the contrary, the word “comprising” and variations such as “comprises” will be understood to imply the inclusion of stated elements but not the exclusion of any other elements. Also, the terms of a unit, a device, and a module in the present specification represent a unit for processing a predetermined function or operation, which can be realized by hardware, software, or a combination of hardware and software.

A method for a video encoder according to an exemplary embodiment of the present invention to determine an inter mode will now be described with reference to the accompanying drawings. The H.264/AVC type video encoder will be exemplified in the exemplary embodiment of the present invention, and other types of video encoders using the inter mode are also applicable.

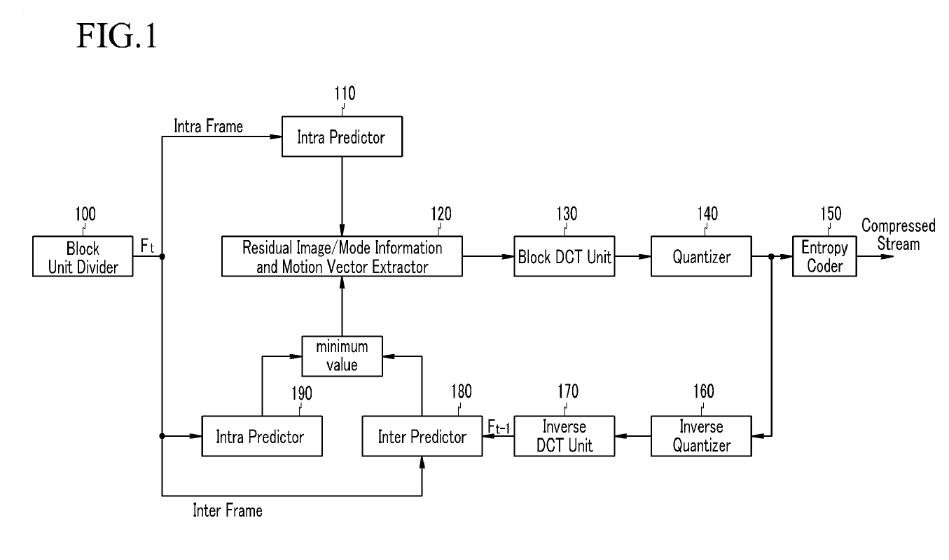

FIG. 1 is a video encoder for compressing block-based data according to an exemplary embodiment of the present invention.

Referring to FIG. 1, the video encoder includes a block unit divider 100, intra predictors 110 and 190, a residual image/mode information and motion vector extractor 120, a block discrete cosine transform (DCT) unit 130, a quantizer 140, an entropy coder 150, an inverse quantizer 160, an inverse DCT unit 170, and an inter predictor 180.

The video data input to the video encoder are classified as an intra frame (I-frame) and an inter frame (P-frame). The intra frame performs intra prediction, and the inter frame performs both intra prediction and inter prediction.

When the video data are input, the block unit divider 100 divides the video data that are input for each frame into macroblocks. The subsequent encoding process is performed by the macroblocks. For example, the macroblock may have a 16×16 block size in the H.264/AVC video encoder.

When the input video data corresponds to the intra frame, the intra predictor 110 performs intra prediction for each macroblock, and determines the intra mode having the minimum rate-distortion cost. The residual image/mode information and motion vector extractor 120 extracts residual image/mode information depending on the intra mode that has the minimum rate-distortion cost selected by the intra predictor 110. The extracted residual image/mode information is discrete cosine transformed by the block DCT unit 130 and is then quantized through the quantizer 140. The quantization result is processed to be a compression stream through the entropy coder 150.

When the input video data are an inter frame, the video encoder uses a previously-encoded previous frame so as to perform inter prediction. For this, the video encoder performs a compression process and a restoration process for each frame to use the restored frame for next-frame inter prediction. That is, the video encoder uses the video data that are generated by restoring the previous frame so as to perform the compression process in the current frame. The restoration process includes inverse quantizing the output of the quantizer 140 through the inverse quantizer 160, and performing inverse DCT on the same through the inverse DCT unit 170.

The inter predictor 180 performs an inter prediction process for each macroblock by using the restored previous frame, and performs a corresponding motion estimation process. Also, the inter predictor 180 determines the inter mode having the minimum rate-distortion cost through the inter prediction process, and determines the corresponding minimum rate-distortion cost.

The intra predictor 190 performs a prediction process for each candidate mode to select the intra mode having the minimum rate-distortion cost from among the candidate modes. The video encoder selects the mode having the lesser rate-distortion cost as a prediction mode for the corresponding frame from among the inter mode and the intra mode having the selected minimum rate-distortion cost through the inter predictor 180 and the intra predictor 190. When the prediction mode for the corresponding macroblock is finally determined, the residual image/mode information and motion vector following the corresponding prediction mode are generated into a compression stream through the above-described process for the intra frame.

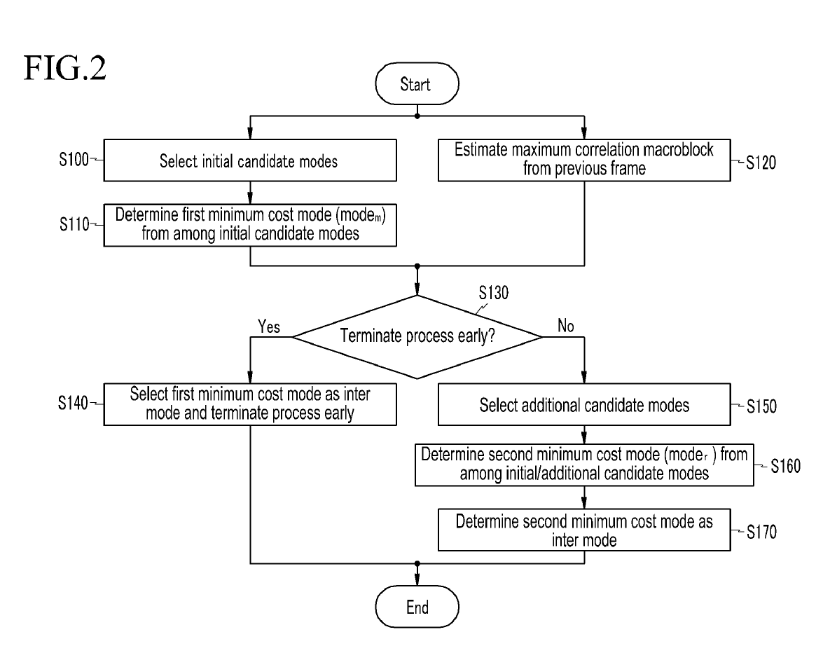

FIG. 2 is a flowchart for a video encoder according to an exemplary embodiment of the present invention to determine an inter mode.

On receiving the video data corresponding to the inter frame, the inter predictor 180 performs a inter prediction process for each macroblock by using the data that are divided by macroblocks by the block unit divider 100.

Referring to FIG. 2, on receiving the macroblock data to be currently encoded (referred to as a current macroblock hereinafter), the inter predictor 180 selects initial candidate modes by using the temporal similarity with the previous frame (S100). That is, the inter predictor 180 selects the initial candidate modes by using inter mode (Modeₘ) information of the same position macroblock of the previous frame. Here, the previous frame represents the frame that is input to the video encoder and is then encoded before the current frame in which the current macroblock is positioned.

The inter predictor 180 performs an inter prediction process on the selected initial candidate modes, and determines the mode having the minimum rate-distortion cost (referred to as a first minimum cost mode hereinafter) from among the initial candidate mode (S110).

The inter predictor 180 performs an inter prediction process on the initial candidate mode and determines whether to terminate the inter mode determination process early. To achieve this, the inter predictor 180 selects the maximum correlation macroblock having the maximum correlation in the previous frame (S120). The inter predictor 180 compares the rate-distortion cost of the maximum correlation macroblock and the rate-distortion cost of the first minimum cost mode and selects whether to terminate the inter mode determination process early (S130).

When the early termination is determined, the inter predictor 180 selects the first minimum cost mode as the inter mode of the current macroblock, and terminates the inter mode determination process early (S140). When the early termination condition is not satisfied, the inter predictor 180 selects additional candidate modes for performing a subsequent inter prediction process (S150).

When the additional candidate modes are determined, the inter predictor 180 additionally performs an inter prediction process on the corresponding modes, and determines a second minimum cost mode having the minimum rate-distortion cost from among the initial candidate modes and the additional candidate modes (S160).

The inter predictor 180 finally determines the second minimum cost mode as the inter mode and terminates the inter prediction process (S170).

The rate-distortion cost of the inter mode determined as described above is compared again with the rate-distortion cost of the intra mode determined through intra prediction, and is then used to determine the prediction mode of the current macroblock.

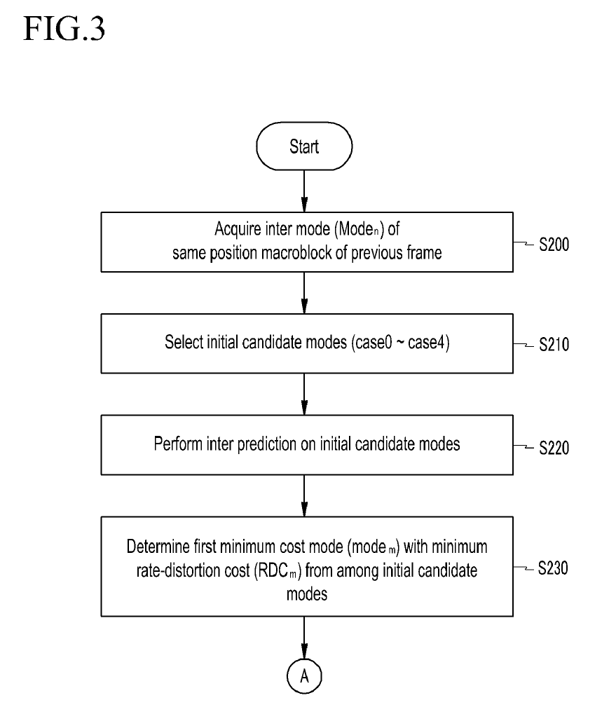

A method for selecting the initial candidate mode in S100 will now be described with reference to FIG. 3 to FIG. 6.

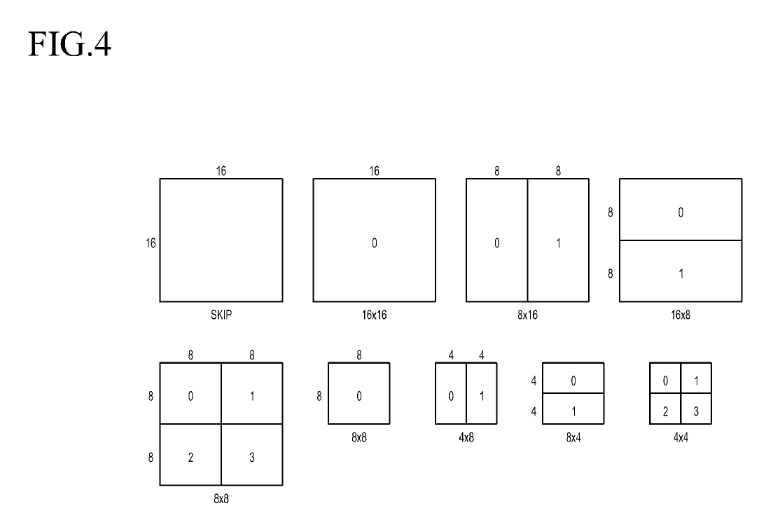

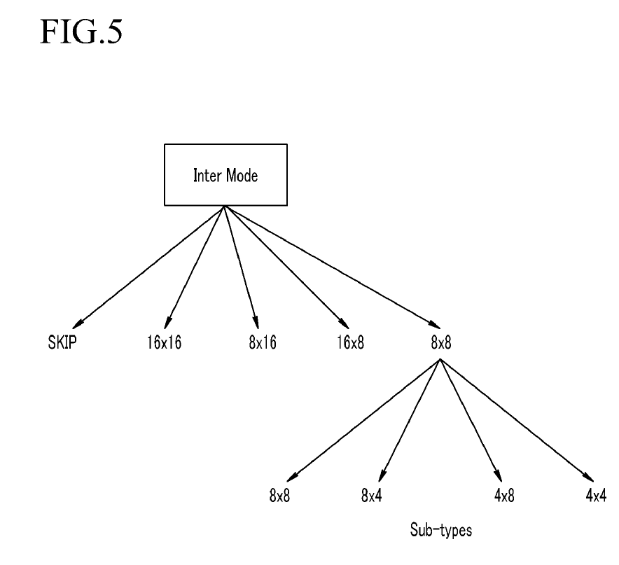

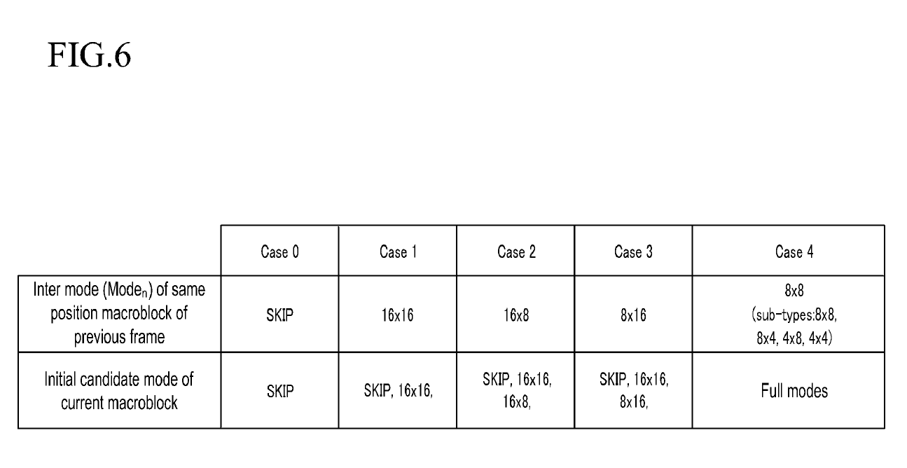

FIG. 3 is a flowchart for a video encoder according to an exemplary embodiment of the present invention to select an initial candidate mode, FIG. 4 shows candidate modes according to an exemplary embodiment of the present invention, and FIG. 5 is a tree-type candidate mode according to an exemplary embodiment of the present invention. FIG. 6 show initial candidate modes according to an exemplary embodiment of the present invention.

Referring to FIG. 3, the inter predictor 180 acquires inter mode (Modeₙ) information of the macroblock having the same position of the current macroblock in the previous frame so as to select the initial candidate modes (S200). There is no need to additionally generate the inter mode information for each macroblock of the previous frame since the inter mode information is generated during the encoding process of the previous frame.

The inter predictor 180 determines initial candidate modes for performing an inter prediction process based on the inter mode (Modeₙ) information of the same position macroblock of the previous frame (S210). The determination of the initial candidate modes as described above is based on the temporal similarity between continuous frames according to the characteristic of video, and the correlation between the inter modes becomes very great in the case of the macroblock in which movement between continuous frames is rare.

As shown in FIG. 4, the candidate modes required for inter prediction in the H.264/AVC method are classified as SKIP, 16×16, 16×8, 8×16, 8×8, 4×8, 8×4, and 4×4. That is, one of 16×16, 16×8, 8×16, and 8×8 is selected according to the block size used for motion estimation, and in the case of 8×8, one of 8×8, 4×8, 8×4, and 4×4 is selected as a sub-mode (sub-type) for each 8×8 block depending on the size of dividing one 8×8 block into smaller ones. Also, the SKIP mode does not perform the motion estimation process, which is shown as a tree in FIG. 5.

The inter predictor 180 performs an inter prediction process on the modes that are selected as candidate modes from among the above-noted 8 inter modes, compares the rate-distortion costs that are generated for the respective candidate modes, and finally selects the inter mode having the minimum rate-distortion cost as the inter mode of the current macroblock.

Referring to FIG. 6, the initial candidate mode includes an inter mode and a SKIP mode of the same position macroblock of the previous frame, and is selected to include the mode having the block size that is greater than that of the inter mode of the same position macroblock of the previous frame. For example, the initial candidate mode becomes SKIP and 16×16 when the inter mode (Modeₙ) of the same position macroblock of the previous frame is 16×16 (i.e., Case 1). The inter mode information in the previous frame has a great correlation with the macroblock at the same position in the current frame. Therefore, determination of the initial candidate mode according to the inter mode (Modeₙ) of the same position macroblock in the previous frame allows efficient selection of the candidate mode without additional calculation. Regarding Case 4 shown in FIG. 6, when the inter mode of the same position macroblock in the previous frame is 8×8 (sub-types: 8×8, 8×4, 4×8, and 4×4), the inter prediction process is performed on all types of candidate modes, that is, the full modes.

Referring to FIG. 3 again, when the initial candidate modes are determined, the inter predictor 180 performs an inter prediction process for each initial candidate mode (S220), and calculates the corresponding rate-distortion cost for each initial candidate mode. Also, the inter predictor 180 selects the candidate mode having the minimum rate-distortion cost (RDCₘ) as a first minimum cost mode (modeₘ) from among the initial candidate modes (S230).

In general, the video encoder selects the optimal compression condition by using the rate-distortion optimization in the prediction process. Equation 1 expresses the method for calculating the rate-distortion cost (J_{R-D}), and the rate-distortion costs of the initial candidate modes can found in the inter prediction process as follows.

J_{R-D}=SAD_{Mode}+λ·{R(Header)+(R(Residual)} [Equation 1]

Here, J_{R-D} is a cost function for the rate-distortion cost, SAD_{Mode} is the sum of errors in the given prediction mode, that is, the corresponding candidate mode, λ is the Lagrangian coefficient, R(x) is the amount of bits for coding the variable x, Header is header information of the current macroblock, and Residual is residual data of the current macroblock when the inter prediction process is performed with the given prediction mode.

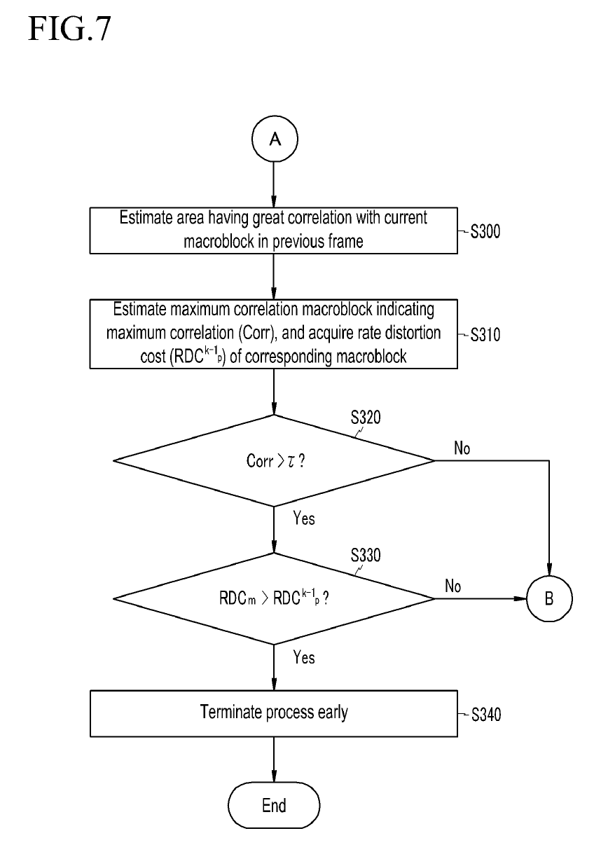

As described with reference to FIG. 2, when the first minimum cost mode (modeₘ) is selected from among the initial candidate modes, the inter predictor 180 determines whether to terminate the inter mode determination process early (S130). A method for determining the early termination in S130 of FIG. 2 will now be described in detail with reference to FIG. 7 to FIG. 9.

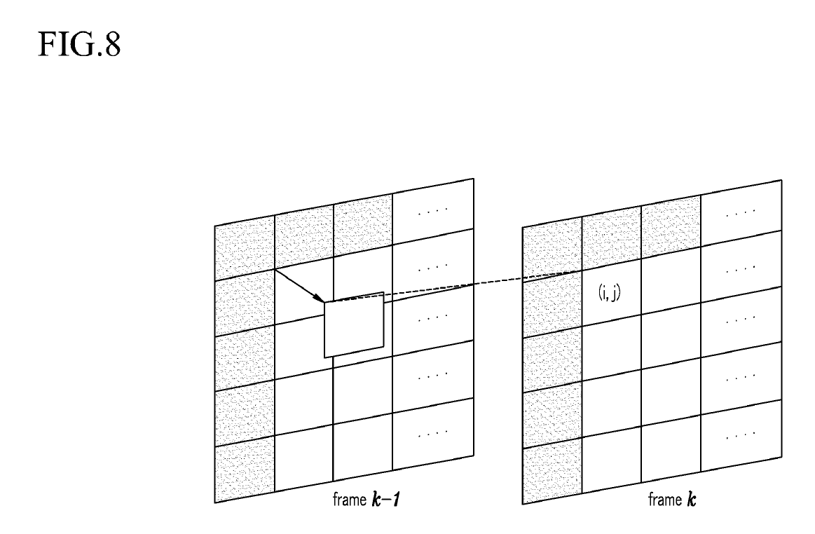

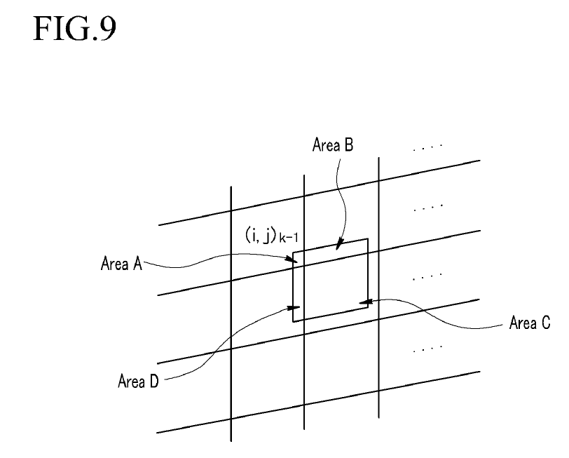

FIG. 7 is a flowchart for a video encoder according to an exemplary embodiment of the present invention to determine an early termination for an inter mode determination process, FIG. 8 is a method for tracking the area having the greatest correlation with the current macroblock in the previous frame according to an exemplary embodiment of the present invention, and FIG. 9 is a method for tracking the area having a great correlation with the current macroblock according to an exemplary embodiment of the present invention.

As shown in FIG. 7, in order to determine the early termination state in the inter mode determination process, the inter predictor 180 estimates the area having the greatest correlation with the current macroblock in the previous frame (S300). Having estimated the area having the greatest correlation, the inter predictor 180 extracts the macroblocks that are superimposed in the corresponding area.

As shown in FIG. 8, when the area having a great correlation with the macroblock (i,j) of the current frame (frame k) is selected in the previous frame (frame k−1), the inter predictor 180 can detect the macroblocks (Area_{A}, Area_{B}, Area_{C}, and Area_{D}) that are superimposed with the area selected in the previous frame as shown in FIG. 9.

Referring to FIG. 9, the inter predictor 180 estimates the maximum correlation macroblock showing the maximum correlation (Corr) from among the superimposed macroblocks (Area_{A}, Area_{B}, Area_{C}, and Area_{D}) (S310). Equation 2 expresses the method for finding the maximum correlation (Corr) for the superimposed macroblocks (Area_{A}, Area_{B}, Area_{C}, and Area_{D}).

Corr=max_{MB}{Area_{A}, Area_{B}, Area_{C}, Area_{D}} [Equation 2]

In general, the correlation of the macroblock that is superimposed the most from among the superimposed macroblocks is selected as the maximum correlation (Corr), which is expressed in Equation 2.

The inter predictor 180 determines the condition of Equation 3 so as to guarantee the reliability of the maximum correlation.

Corr>T [Equation 3]

That is, the inter predictor 180 determines whether the maximum correlation (Corr) exceeds the predetermined threshold value (T) (S320), and determines whether to terminal the inter mode determination process early by using the rate-distortion cost (RDC^{k-1}ₚ) of the maximum correlation macroblock when it exceeds the predetermined threshold value.

When the maximum correlation (Corr) of the maximum correlation macroblock exceeds the threshold value, the inter predictor 180 determines whether the rate-distortion cost (RDCₘ) of the first minimum cost mode satisfies the condition of Equation 4 (S330).

RDCₘ<RDC^{k-1}ₚ [Equation 4]

That is, when the rate-distortion cost (RDCₘ) of the first minimum cost mode is less than the rate-distortion cost (RDC^{k-1}ₚ) of the maximum correlation macroblock, the inter predictor 180 selects the first minimum cost mode as the inter mode of the current macroblock and terminates the inter mode determination process early (S340).

When the rate-distortion cost (RDCₘ) of the first minimum cost mode is greater than the rate-distortion cost (RDC^{k-1}ₚ) of the maximum correlation macroblock, the inter predictor 180 selects an additional candidate mode in a like manner of S150 and S160 in FIG. 2, and performs an additional inter prediction process on the corresponding modes.

The rate-distortion cost of the maximum correlation macroblock is the value that is calculated during the encoding process of the previous frame.

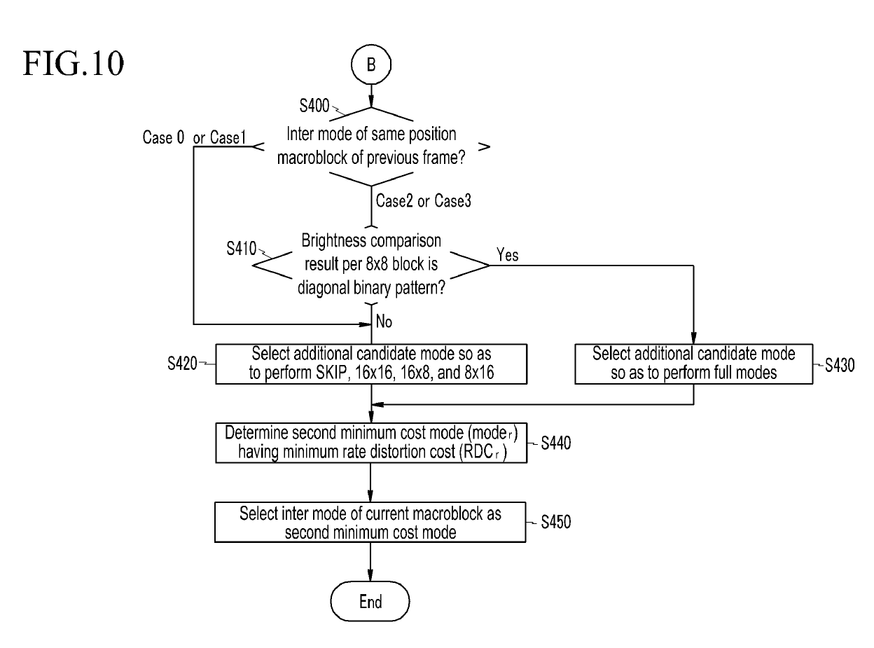

A method for selecting an additional candidate mode in S150 and S160 of FIG. 2 and selecting a second minimum cost mode will now be described with reference to FIG. 10 to FIG. 13.

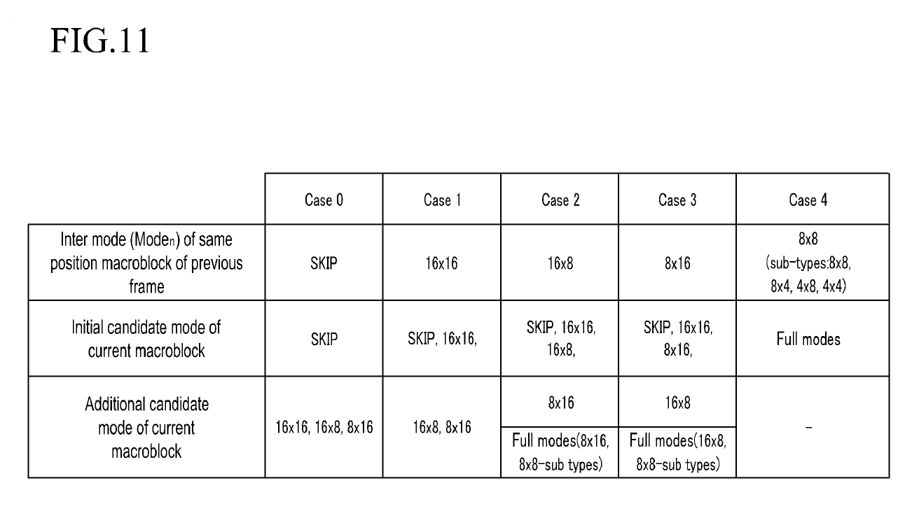

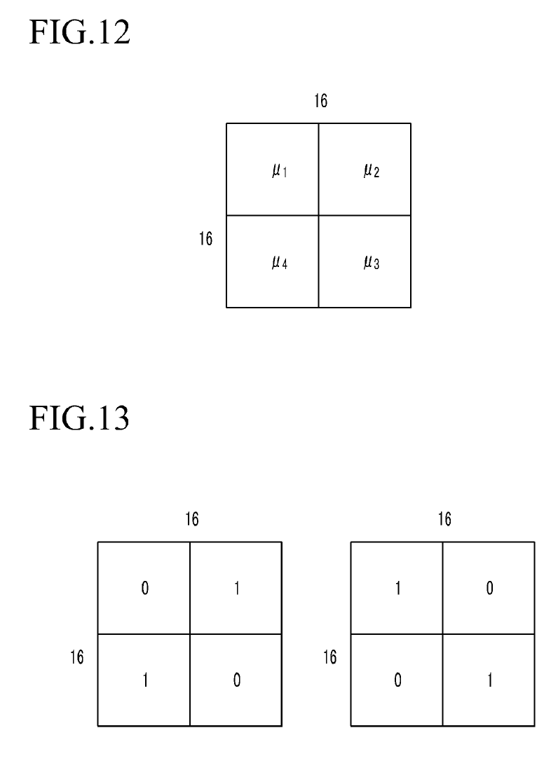

FIG. 10 is a flowchart for a video encoder according to an exemplary embodiment of the present invention to determine the inter mode according to selection of an additional candidate mode, and FIG. 11 is an example of selecting an additional candidate mode according to an exemplary embodiment of the present invention. Also, FIG. 12 and FIG. 13 show a method for analyzing spatial uniformity so as to select an additional candidate mode for Case 2 and Case 3 according to an exemplary embodiment of the present invention.

Referring to FIG. 10, when failing to satisfy the early termination condition, the inter predictor 180 selects additional candidate modes so as to additionally perform the inter prediction process. The inter predictor 180 selects the additional candidate modes according to the inter mode of the same position macroblock of the previous frame in a like manner of the method of selecting the initial candidate mode. When the inter mode corresponding to the same position macroblock of the previous frame is the SKIP mode (Case 0) or the 16×16 mode (Case 1) (S400), the inter predictor 180 selects additional candidate modes so as to perform the inter prediction process on the SKIP, 16×16, 16×8, and 8×16 modes (S420). For example, as shown in FIG. 11, the inter predictor 180 selects 16×16, 16×8, and 8×16 modes as additional candidate modes and performs the inter prediction process since it has selected the SKIP mode as the initial candidate mode in the case of Case 0.

Further, when the inter mode corresponding to the same position macroblock of the previous frame is 16×8 (Case 2) or 8×16 (Case 3) (S400), the inter predictor 180 determines whether to select an additional candidate mode (S420) so that the prediction process may be performed on the SKIP, 16×16, 16×8, and 8×16 modes according to the spatial uniformity (S410), or whether to select an additional candidate mode (S430) so that the prediction process may be performed on the full modes (SKIP, 16×16, 16×8, 8×16, 8×8 sub-types (8×8, 8×4, 4×8, 4×4)).

Referring to FIG. 12, when the inter mode corresponding to the same position macroblock of the previous frame is 16×8 (Case 2) or 8×16 (Case 3), the inter predictor 180 divides the current macroblock by the size of 8×8 to thus generate the mean value of four 8×8 blocks (μᵢ, i=0, 1, 2, 3). The inter predictor 180 compares the average brightness value of the calculated 8×8 block and the average brightness value (PT) of the full macroblocks 16×16, allocates 1 to the corresponding 8×8 block when μ_{T}<μᵢ, and allocates 0 in another case.

The inter predictor 180 checks the binary pattern for allocating 0 or 1 to the 8×8 block, and selects the additional candidate modes so as to perform an inter prediction process on the full modes for Case 2 and Case 3 when there is a diagonal binary pattern as shown in FIG. 13. In addition, when there is no diagonal binary pattern, the additional candidate mode is selected from among SKIP, P16×16, P16×8, and P8×16.

When the inter mode corresponding to the same position macroblock of the previous frame is a mode corresponding to the block that is less than 8×8, the first minimum cost mode is selected as the inter mode of the current macroblock without further selection of an additional candidate mode since the initial candidate mode includes the full modes.

Referring to FIG. 10, when the additional candidate modes are selected as described above in S420 and S430, the inter predictor 180 performs an inter prediction process on the corresponding additional candidate modes. The inter predictor 180 determines a second minimum cost mode having the minimum rate-distortion cost (RDCᵣ) from among the candidate modes (initial candidate modes and additional candidate modes) to which the prediction process is performed with reference to the current macroblock (S440), and selects the second minimum cost as the inter mode of the current macroblock (S450).

The described method for determining the inter mode of the macroblock by performing the inter prediction process on the candidate modes that are selected according to the condition reduces complexity compared to the conventional method for determining the mode that has the minimum rate-distortion cost as the inter mode by performing the prediction process on the full modes. Also, the method is applicable to the real-time image processing system by reducing complexity and increasing efficiency of the encoding system.

The above-described embodiments can be realized through a program for realizing functions corresponding to the configuration of the embodiments or a recording medium for recording the program in addition to through the above-described device and/or method, which is easily realized by a person skilled in the art.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

According to the exemplary embodiment of the present invention, the method for determining the inter mode by using inter mode information for each macroblock of the previous frame and performing an inter prediction process on several candidate modes reduces complexity of the video encoder compared to the conventional inter mode determination method for performing the inter prediction process on the full modes.

Also, in order to determine whether to terminate the inter mode determination process early, the rate-distortion cost of the macroblock having the greatest correlation with the current macroblock in the previous frame is used, and hence reliability for the inter mode that is selected by using the early termination is increased. Further, since there is no need to add another operation for performing the inter mode determination process, rate-distortion cost information or inter mode information generated during the previous frame encoding process is used so that complexity is reduced while reducing the number of times of performing the inter prediction process for selecting the inter mode.

What is claimed is:

1. A method for determining an inter mode in a method for a video encoder to select an inter mode of a current macroblock to be encoded in a current frame, the method comprising:
selecting a first minimum cost mode by using inter mode information on a macroblock of a previous frame corresponding to the current macroblock;
estimating a maximum correlation macroblock having a maximum correlation with the current macroblock in the previous frame; and
determining an inter mode of the current macroblock based on a rate-distortion cost of the first minimum cost mode and a rate-distortion cost of the maximum correlation macroblock.

2. The method of claim 1, wherein
the step of determining the inter mode includes:
determining whether to select a second minimum cost mode other than the first minimum cost mode based on the rate-distortion cost of the first minimum cost mode and the rate-distortion cost of the maximum correlation macroblock; and
determining the first minimum cost mode as the inter mode when not selecting the second minimum cost mode, and selecting the second minimum cost mode as the inter mode when selecting the second minimum cost mode.

3. The method of claim 2, wherein:
the step of selecting the first minimum cost mode includes
selecting at least one initial candidate mode by using inter mode information on a macroblock of the previous frame, and
selecting the first minimum cost mode from among the at least one initial candidate mode; and
the step of determining the inter mode further includes
selecting at least one additional candidate mode by using inter mode information on the macroblock of the previous frame, and
selecting the second minimum cost mode from among the first minimum cost mode and the at least one additional candidate mode.

4. The method of claim 3, wherein
the step of selecting at least one initial candidate mode includes
selecting an inter mode having a size that is equal to or greater than that of the inter mode of the macroblock of the previous frame and a SKIP mode as the at least one initial candidate mode.

5. The method of claim 3, wherein
the step of selecting at least one additional candidate mode includes:
determining the at least one additional candidate mode so that the at least one initial candidate mode and the at least one additional candidate mode may include full inter modes or partial inter modes according to inter mode information of the macroblock of the previous frame.

6. The method of claim 5, wherein
the step of determining at least one additional candidate mode includes:
dividing the current macroblock into a plurality of blocks according to inter mode information of the macroblock of the previous frame;
allocating binary data to each block according to the average brightness value of the plurality of blocks; and
determining the at least one additional candidate mode so that the at least one initial candidate mode and the at least one additional candidate mode may include the full inter modes when the binary datas for the plurality of blocks correspond to a diagonal binary pattern.

7. The method of claim 6, wherein
the inter mode information of the macroblock of the previous frame corresponds to one of the 16×8 mode and the 8×16 mode.

8. The method of claim 5, wherein
the partial inter modes include SKIP, 16×16, 16×8, and 8×16 modes.

9. The method of claim 3, wherein
the mode having the minimum rate-distortion cost from among the initial candidate modes is selected as the first minimum cost mode, and
the mode having the minimum rate-distortion cost from among the first minimum cost mode and the at least one additional candidate mode is selected as the second minimum cost mode.

10. The method of claim 2, wherein
the step of determining whether to select the second minimum cost mode includes:
comparing correlation of the maximum correlation macroblock with a threshold value; and
comparing the rate-distortion cost of the maximum correlation macroblock and the rate-distortion cost of the first minimum cost mode and determining whether to select the second minimum cost mode when the correlation of the maximum correlation macroblock is greater than the threshold value.

11. The method of claim 1, wherein
the step of estimation includes:
estimating the area having the greatest correlation with the current macroblock in the previous frame;
estimating at least one of a macroblock that is superimposed with the area having the greatest correlation; and
selecting the macroblock that is the most superimposed from among the at least one macroblock as the maximum correlation macroblock.

12. The method of claim 1, wherein
the macroblock of the previous frame is a macroblock having the same position as the current macroblock.

13. A method for determining an inter mode in a method for a video encoder to select an inter mode of a current macroblock to be encoded in a current frame, the method comprising:
selecting at least one initial candidate mode by using inter mode information on a macroblock of a previous frame corresponding to the current macroblock;
selecting a minimum cost mode from among the at least one initial candidate mode;
determining whether to terminate the inter mode determination process based on a rate-distortion cost of the minimum cost mode; and
determining the inter mode according to the determination result, and
the step of determining the inter mode includes
determining the minimum cost mode as the inter mode when the inter mode determination process is finished, and selecting at least one additional candidate mode and determining the inter mode from among the minimum cost mode and the at least one additional candidate mode when the inter mode determination process is not finished.

14. The method of claim 13, wherein
the step of determining whether to terminate the inter mode determination process includes:
estimating the maximum correlation macroblock having the greatest correlation with the current macroblock in the previous frame;
comparing the correlation of the maximum correlation macroblock with a threshold value; and
comparing the rate-distortion cost of the minimum cost mode and the rate-distortion cost of the maximum correlation macroblock and determining whether to terminate the inter mode determination process when the correlation of the maximum correlation macroblock is greater than the threshold value.

15. The method of claim 14, wherein
the step of estimation includes:
estimating the area having the greatest correlation with the current macroblock in the previous frame;
selecting at least one macroblock that is superimposed with the area having the greatest correlation in the previous frame; and
estimating the macroblock having the greatest correlation with the current macroblock from among the at least one macroblock as the maximum correlation macroblock.

16. The method of claim 13, wherein
the step of determining the inter mode further includes:
dividing the current macroblock into a plurality of blocks when the inter mode information of the macroblock of the previous frame is one of the 16×8 mode and the 8×16 mode;
allocating binary data according to the average brightness value corresponding to the plurality of blocks; and
selecting the at least one additional candidate mode so that the at least one initial candidate mode and the at least one additional candidate mode may include the full modes when the binary data correspond to a diagonal binary pattern.
